(19) United States
(12) Patent Application Publication
(10) Pub. No.: US 2018/0222165 A1
(43) Pub. Date: Aug. 9, 2018

(54) LOW DENSITY COMPOSITE PANEL

(71) Applicant: Microsoft Technology Licensing, LLC, Redmond, WA (US)

(72) Inventor: Nicholas Wendt, Seattle, WA (US)

(73) Assignee: Microsoft Technology Licensing, LLC, Redmond, WA (US)

(21) Appl. No.: 15/424,093

(22) Filed: Feb. 3, 2017

(51) Int. Cl. B32B 27/12; B32B 5/02; B32B 7/04; B32B 7/12; B32B 27/32; B32B 37/12; B32B 37/10; B32B 37/06; B29C 65/02; B29C 65/52; B29C 65/00

(52) U.S. Cl. CPC B32B 27/12; B29K 2023/12; B32B 7/045; B32B 7/12; B32B 27/32; B32B 37/1284; B32B 37/1027; B32B 37/065; B29C 65/02; B29C 65/522; B29C 66/729; B29C 66/71; B29C 66/721; B32B 2250/03; B32B 2250/24; B32B 2255/10; B32B 2262/0276; B32B 2262/023; B32B 2262/0246; B32B 2262/0253; B32B 2262/14; B32B 2305/38; B32B 2307/72; B32B 2323/04; B32B 2323/10; B32B 2319/00; B32B 2369/00; B29K 2023/06; B32B 5/028

(57) ABSTRACT

Examples are disclosed that relate to lightweight and thin composite panels. One example provides a composite panel comprising a mesh core, a first outer skin layer couple to a first side of the mesh core, and a second face layer coupled to a second side of the mesh core.

### BACKGROUND

Many devices, including but not limited to computing devices such as laptops, tablets and smart phones, incorporate panels of material as device structures. Such panels may be used as device enclosures and also as internal support structures, as examples.

### SUMMARY

Examples are disclosed that relate to lightweight and thin composite panels. One example provides a composite panel comprising a mesh core, a first outer skin layer couple to a first side of the mesh core, and a second face layer coupled to a second side of the mesh core.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A-1B show an example device that may incorporate a composite panel.

FIG. 2 shows a sectional view of an example composite panel.

FIG. 3 shows a sectional view of another example composite panel.

FIG. 4 shows a flow diagram illustrating an example method of manufacturing a composite panel.

FIG. 5 illustrates an example method of manufacturing a composite panel via a press.

FIG. 6 illustrates an example method of manufacturing a composite panel manufacturing via a roller process.

### DETAILED DESCRIPTION

As mentioned above, computing devices may utilize panels of materials in various ways, for example as enclosures and as internal structures (e.g. in a lightweight keyboard) to provide rigidity. As consumer demand continues to drive the development of lighter weight devices, various strategies may be used to decrease the weight of such panels. For example, solid panels may be made thinner and thinner. However, such panels may have relatively high densities, which may limit weight savings. As another strategy, some devices may utilize composite structural panels having a lightweight, low density core sandwiched between thin, strong face layers, instead of using solid panels. However, reducing the weight and thickness of such composite panels may pose various problems. For example, such panels often use foam or honeycomb materials as low-density cores. Honeycomb materials may not be commercially available in thicknesses below 1.5 mm, and foam materials with such thicknesses may not provide sufficient stiffness and may be too compressible for use as a composite core. This may be at least in part due to methods used to form the cores, which may be cut from larger blocks of material.

Accordingly, examples are disclosed that relate to the use of a mesh material as a core in a composite panel. The term “mesh” as used herein signifies a material comprising a plurality of filaments that intersect at joints in such a manner as to form a thin, porous, sheet. Mesh materials may be made by a variety of different manufacturing processes, such as extrusion and expansion, but are manufactured in sheet form without being cut from a larger piece. Meshes may be used for many different purposes, including but not limited to filtration, pest control, and containment applications. Commercially available mesh materials suitable for use as a composite panel core may be much thinner than currently available honeycomb or foam core materials. Further, pores in the mesh provide similar density advantages as conventional foam and honeycomb cores. These and other features are described in more detail below.

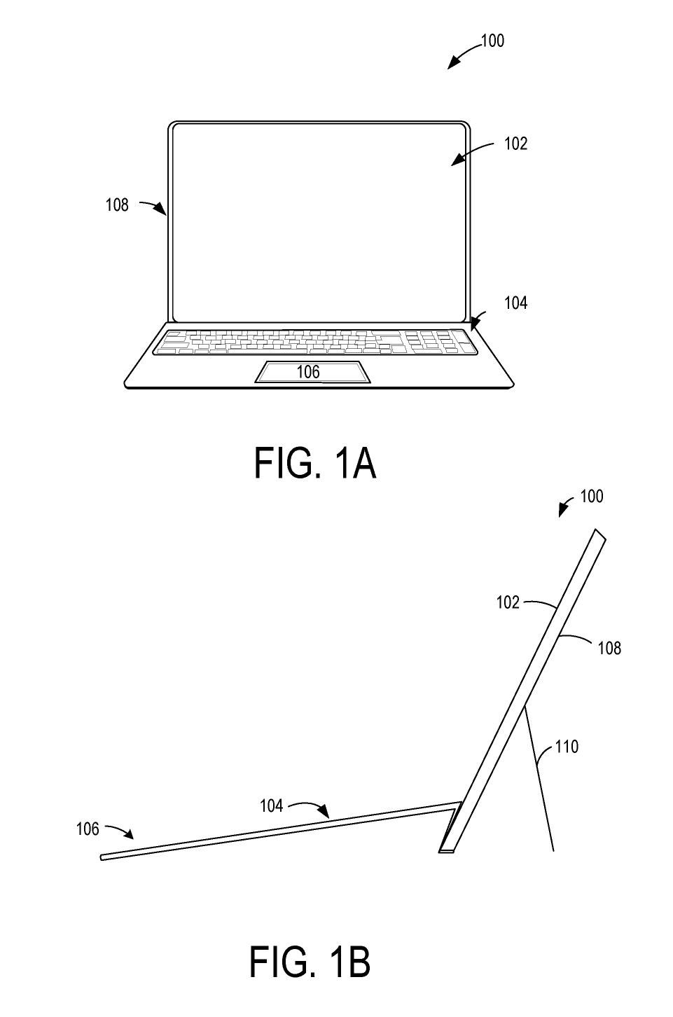

FIGS. 1A and 1B show an example of device 100 in which a composite panel comprising a mesh core may be used. Device 100 takes the form of a portable computing device equipped with a touch screen 102, a keyboard 104 and a touch pad 106. Device 100 may utilize a lightweight composite panel as a material for the enclosure 108 of the portable computing device, as a material for a retractable support stand 110, and/or as a structural support for keyboard 104 and touch pad 106, as examples. While depicted in the context of a portable computing device, it will be understood that a composite panel as disclosed herein may be used in any other suitable device, including but not limited to other electronic devices such as smartphones, multi-user touch displays and televisions.

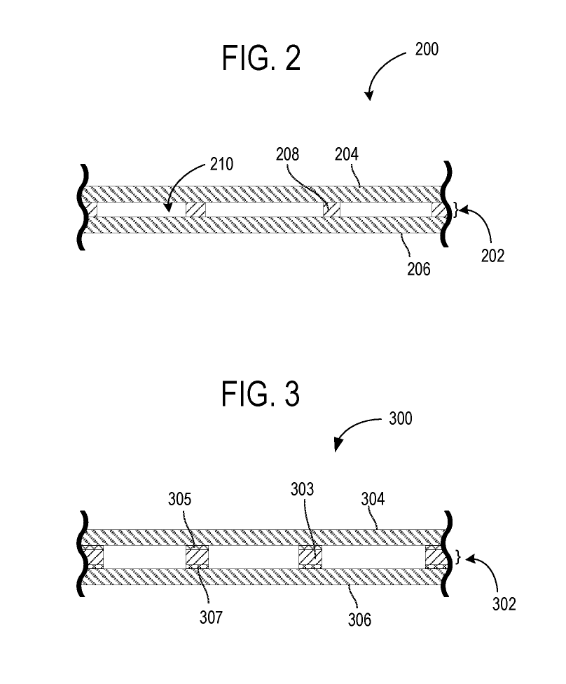

FIG. 2 shows a schematic sectional view of an example composite panel 200. The composite panel comprises a mesh core 202 sandwiched between and bonded to a first face layer 204 and a second face layer 206. The mesh core 202 comprises a plurality of filaments 208 arranged in an intersecting pattern that define a plurality of pores 210. The filaments may be arranged in a square pattern, diamond pattern, rectangular pattern, irregular pattern, or in any other suitable manner. The pores 210 in the mesh core 202 reduce the weight of the mesh core 202 relative to a solid core, while the filaments 208 support the first face layer 204 and the second face layer 206 against inward bowing/crushing.

The mesh core 202 may be formed from any suitable mesh material. Current meshes are commercially available in a wide range of materials, such as metals and plastics. Meshes are also available in a wide range of thicknesses, filament sizes and pore sizes, including thickness that are lower than commercially available honeycomb and foam sheets for composite panel cores. Examples of suitable mesh materials include wire cloth and plastic meshes sold by McMaster-Carr of Elmhurst, Ill. Examples of suitable thicknesses for the mesh core 202 include thicknesses in a range of 0.3 mm to 1.4 mm, which may be lower than the thicknesses of commercially available honeycomb and foam core materials. Examples of suitable dimensions for pores 210 include, but are not limited to, pore sizes of that have an average width size equal to or less than the thickness of the first face layer 204 and the second fact layer 206.

The first face layer 204 and the second face layer 206 may be formed from any suitable material or materials. Examples include, but are not limited to, composite materials (e.g. thermoplastic composites, fiberglass, para-aramid synthetic fibers (e.g. Kevlar, available from E. I. du Pont de Nemours and Company of Wilmington, Del.) or carbon fiber composites), metal or metal-containing materials, and plastic materials. As a more specific example, the first face layer 204 and second face layer 206 each may be formed from a composite thermoplastic polymer material, such as polypropylene or polyethylene comprising embedded fibers. In such examples, as mentioned above, the use of a thermoplastic polymer mesh in combination with a suitable thermoplastic sheet for the first face layer 204 and/or the second face layer 206 may allow the mesh core 202 to be welded to the first face layer 204 and/or the second face layer 206 via the application of heat and pressure. Such a structure is depicted in FIG. 2, in which an adhesive is not shown between the mesh core 202 and either of the first face layer 204 and the second face layer 206. Forming a welded joint between the mesh core 202 and the face layers may help to maintain a lower weight relative to the use of adhesives, which add mass and also may occupy pore area.

The first face layer 204 and the second face layer 206 each may have any suitable thickness. The first face layer 204 and the second face layer 206 may be thinner than the mesh core 202, as such a structure may result in a lower overall density of the composite panel compared to the use of thicker face layers. Examples of suitable thickness for the first and second face layers include, but are not limited to, thicknesses between 0.05 millimeters and 0.3 millimeters, and examples of suitable densities for the overall composite panel include, but are not limited to, densities of between 0.5 and 1.6 grams/cm³. As a more specific example, the composite panel may comprise a polycarbonate or polycarbonate/ABS (acrylonitrile butadiene styrene) mesh core 202 having a thickness of 0.5 mm, and a first face layer 204 and second face layer 206 each having a thickness of 0.15 mm, thereby producing an overall panel thickness of 0.8 mm with a density of 1.0 g/cm³. In comparison, a 0.8 mm thick panel of solid magnesium would have a density of 1.8 g/cm³, which is significantly higher.

The thickness of the first face layer 204 and the second face layer 206 may be the same or different, and may vary as a function of position, depending upon a configuration of a product incorporating the composite panel 200. For example, a thickness of the panel may be varied to form a tapered edge of a device, or to provide reinforcement at selected locations from dropping or impact damage. In instances where the materials from which the mesh core and face layers are made cannot be welded to one another, the mesh core and face layers may be bonded together in any other suitable manner, such as via an adhesive.

FIG. 3 shows an example of composite panel 300 in which a mesh core 302 comprising a plurality of filaments 303 is bonded to a first face layer 304 via a first adhesive layer 305, and to a second face layer 306 via a second adhesive layer 307. Any suitable adhesive may be used to bond the mesh core 302 to the first face layer 304 and/or the second face layer 306. In some examples, a thin layer of a relatively viscous adhesive or primer may be used. The use of a more viscous material as opposed to a less viscous material may help to prevent adhesive from entering the pores, or otherwise reduce the amount of adhesive that enters the pores, and thereby may help to maintain a lower overall density of the core. The adhesive may be curable (e.g. photocurable by x-ray or UV light, or thermally curable) and/or pressure-sensitive in various examples. The adhesive may be applied to the mesh core 302, to the first face layer 304 and the second face layer 306, or to both the mesh core 302 and the first and second face layers 304, 306, and may be applied in any suitable manner. Examples include, but are not limited to, spray processes and roller application processes. After application, the composite panel may be formed by compressing the first face layer 304 and the second face layer 306 against the mesh core material 302.

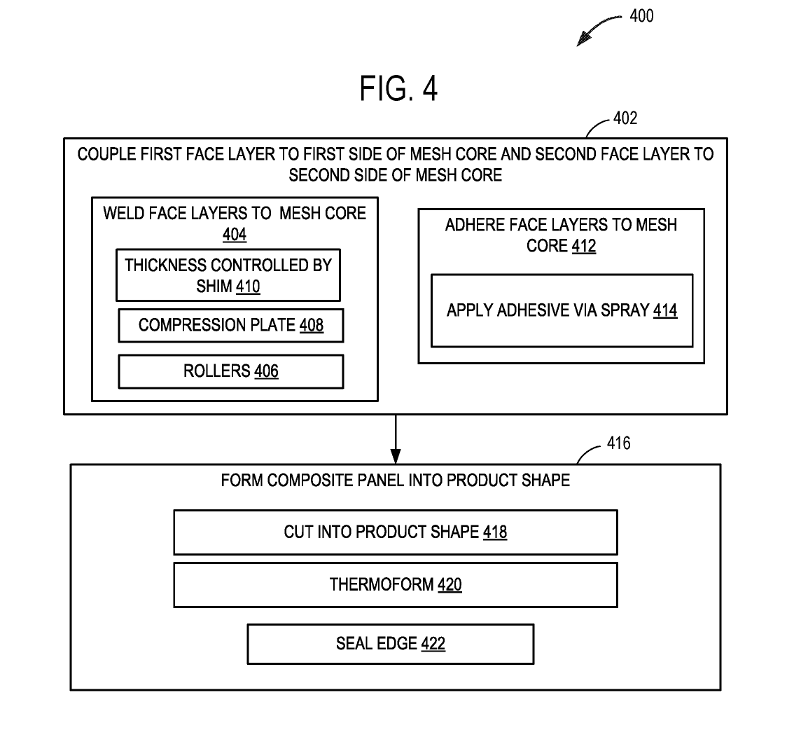

FIG. 4 shows a flow diagram 400 illustrating an example method of manufacturing a composite panel. Method 400 comprises, at 402, coupling a first face layer to a first side of a mesh core and a second face layer to a second side of the mesh core. In some examples, this coupling may be accomplished by welding the first and second face layers to the mesh core, as indicated at 404. The weld may be formed by heating the mesh core and face layers while pressing the outer layers upon the mesh core via rollers or a roller system, as indicated at 406. The weld also may be formed via compression plates, as indicated at 408. Such plates may similarly apply heat and pressure in a batch manner, whereas rollers may be applied in a continuous flow process. In either case, a thickness of the composite panel and/or pressure applied may be controlled by a motion-limiting shim 410.

In other examples, the coupling of the first face layer to the first side of the mesh core and the second face layer to the second side of the mesh core via an adhesive, as indicated at 412. In such an example, the adhesive may be applied in any suitable manner. As one example, an adhesive may be applied to one or more of the mesh core, the first face layer and the second face layer via spraying. As another example, the adhesive may be applied by a roller. After application of the adhesive, the composite panel may be formed by applying the face layers to the mesh core, potentially with the application of pressure, heat, UV light, x-rays, and/or other energy to help ensure that the face layers are bonded strongly to the mesh core.

In some examples, the face layers and mesh core are pre-cut into a product shape and then coupled together. In such examples, the final product may be substantially formed by coupling the parts together. In other examples, a composite panel may be formed in an arbitrary shape and then machined into a final product shape. Thus, at 416, method 400 optionally may comprise forming the composite panel into a product shape. This may include, at 418, cutting the composite panel into the product shape. Cutting may be performed via laser cutting, water jet, manually cutting, or any other suitable cutting method. Additionally or alternatively, as indicated at 420, the composite panel may be thermoformed into a contoured product shape. In some examples, cutting and/or contouring may be performed via tooling integrated with a press used to laminate or weld the first and second face layers to the mesh core.

Continuing with FIG. 4, forming the composite panel into product shape 416 may further comprise sealing an edge of the composite panel 422. An edge seal may be formed in any suitable manner. For example, perimeter regions of the first and second face layers may extend beyond a perimeter of the mesh core, and thus be sealed by compression and heat. Additionally or alternatively, an adhesive may be applied in the edge region to seal the edge.

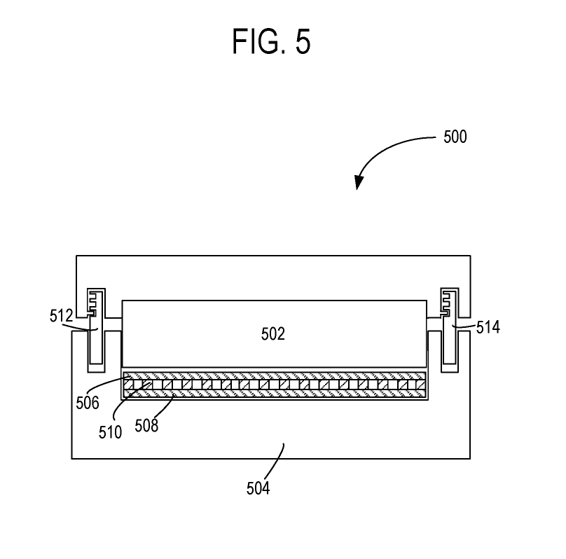

FIG. 5 shows an example press system 500 for forming a composite panel in a batch process. The depicted press system comprises a first plate 502 and a second plate 504 configured to compress the composite panel during manufacturing to join the face layers 506, 508 to the mesh core 510, for example via an adhesive or welded joint. In the depicted embodiment, the press system 500 comprises shims 512 and 514. Shims 512 and 514 may be used to prevent the composite panel from being overcompressed during manufacturing, and thus may help to ensure that composite panels are made to a consistent thickness. Further, in some examples, the first plate 502 and/or the second plate 504 may comprise a heating system configured to heat the composite panel during manufacturing. In the depicted example, the shims are shown as being adjustable. This may allow, for example, a relatively thicker shim to be used for a first manufacturing step, and relatively thinner shim may be used for a second manufacturing step.

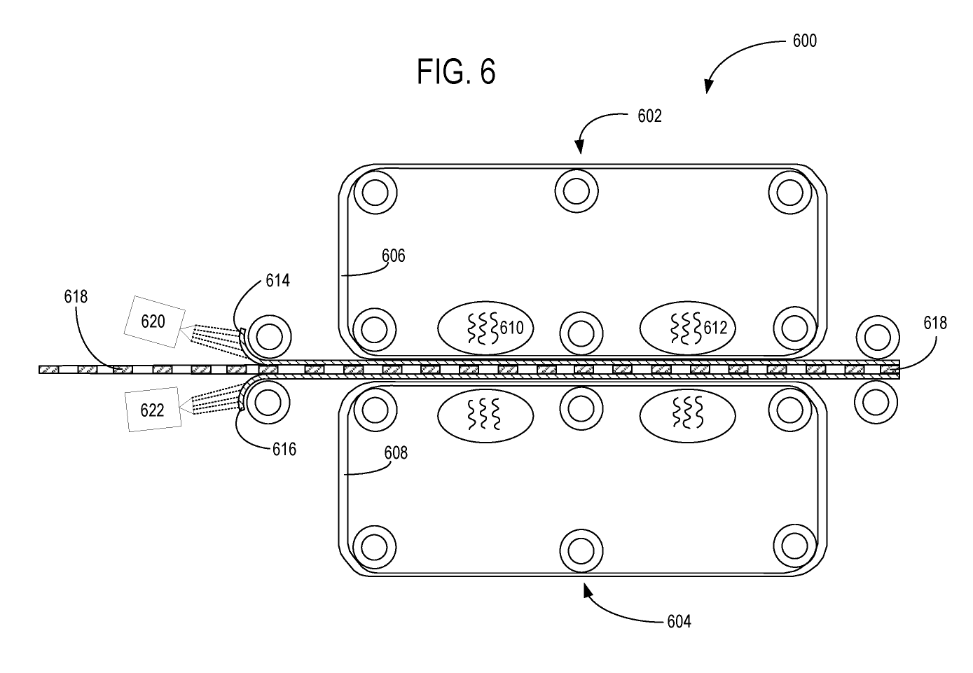

FIG. 6 shows an example roller system for forming a composite panel manufacturing on a system of rollers 600 which may be used to couple face layers to the mesh core. As an example, system 600 uses two groups of rollers 602 and 604 opposite one another, and belt systems 606 and 608 to drive the composite panels through. Heaters 610 and 612 may be used to apply heat to weld the face layers 614 and 616 to the mesh core 618 or to cure an adhesive. Additionally or alternatively, optional sprayers 620 and 622 may be used to spray adhesive onto the face layers before coupling to the mesh core. Such sprayers alternatively or additionally may be configured to spray adhesive onto the mesh core. In other examples, an adhesive may be applied via roller or other contact-based method to the face layers and/or the mesh core.

The roller systems 602, 604 may be configured to supply any suitable amount of compression. In some examples, a series of roller systems may provide increased compression as the composite panel moves through the plurality of roller systems. Likewise, in some examples, rollers may be used to form a product shape, e.g. by cutting a panel after the panel has been formed. In any of these examples, a composite panel may be cut to the size and shape of the part after being formed, or may be initially formed in the shape of the part.

Another example provides a composite panel comprising a mesh core, a first face layer coupled to a first side of the mesh core, and a second face layer coupled to a second side of the mesh core, wherein the mesh core has a thickness of between 0.3 and 1.4 millimeters. In some such examples, the composite panel alternatively or additionally may have a thickness between 0.5 and 2.5 millimeters. In some such examples, the first face layer and the second face layer alternatively or additionally may be formed at least partially from a thermoplastic material. In some such examples, the first face layer and the second face layer each alternatively or additionally may have a thickness of between 0.05 millimeters and 0.3 millimeters. In some such examples, the first face layer and the second face layer alternatively or additionally may be coupled respectively to the first side of the mesh core and the second side of the mesh core via welds. In some such examples, the first face layer and the second face layer alternatively or additionally may be coupled to the mesh core via an adhesive. In some such examples, the mesh, the first face layer, and the second face layer alternatively or additionally may each be at least partially formed from a same thermoplastic material.

Another example provides a composite panel comprising a thermoplastic mesh core, a first face layer comprising a thermoplastic material welded to a first side of the thermoplastic mesh core, and a second face layer comprising a thermoplastic material welded to a second side of the thermoplastic mesh core. In some such examples, the composite panel alternatively or additionally may have a density of between 0.5 grams per cubic centimeter and 1.6 grams per cubic centimeter. In some such examples, the thermoplastic mesh core additionally or alternatively may include pores having an average width equal to or less than a thickness of the first thermoplastic face layer. In some such examples, the thermoplastic mesh core alternatively or additionally may have a thickness between 0.3 and 1.4 millimeters.

Another example provides a method for manufacturing a composite panel, the method comprising coupling a first face layer to a first side of a mesh core, and coupling a second face layer to a second side of the mesh core to form the composite panel, wherein the mesh core has a thickness of between 0.3 and 1.4 millimeters. In some such examples, coupling the first face layer to the first side of the mesh core and the coupling the second face layer to the second side of the mesh core may additionally or alternatively include welding the first face layer and the second face layer to the mesh core. In some such examples, welding the first face layer and the second face layer to the mesh core may additionally or alternatively include pressing the first face layer against the first side of the mesh core and the second face layer against the second side of the mesh core while applying heat. In some such examples, coupling the first face layer to the first side of the mesh core and the coupling of the second face layer to the second side of the mesh core may additionally or alternatively include adhering the first face layer and the second face layer to the mesh core via an adhesive. In some such examples, applying the adhesive may additionally or alternatively include spraying the adhesive. In some such examples, coupling the first face layer to the first side of the mesh core and coupling the second face layer to the second side of the mesh core may additionally or alternatively include applying pressure via compression surfaces equipped with a motion-limiting shim to control a thickness of the composite panel. In some such examples, coupling the first face layer and the second face layer to the first side of the mesh core and the second side of the mesh core may additionally or alternatively include pressing the first face layer and the second face layer to the mesh core via rollers. In some such examples, the method may additionally or alternatively include forming the composite panel into a product shape. In some such examples, forming the composite panel into the product shape may additionally or alternatively include one or more of cutting the composite panel after coupling the first face layer and the second face layer to the mesh core, thermoforming the composite core into the product shape, and sealing an edge of the product shape.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A composite panel comprising:
a mesh core;
a first face layer coupled to a first side of the mesh core; and
a second face layer coupled to a second side of the mesh core, wherein the mesh core has a thickness of between 0.3 and 1.4 millimeters.

2. The composite panel of claim 1, wherein the composite panel has a thickness between 0.5 and 2.5 millimeters.

3. The composite panel of claim 1, wherein the first face layer and the second face layer are formed at least partially from a thermoplastic material.

4. The composite panel of claim 1, wherein the first face layer and the second face layer each has a thickness of between 0.05 millimeters and 0.3 millimeters.

5. The composite panel of claim 1, wherein the first face layer and the second face layer are coupled respectively to the first side of the mesh core and the second side of the mesh core via welds.

6. The composite panel of claim 1, wherein the first face layer and the second face layer are coupled to the mesh core via an adhesive.

7. The composite panel of claim 1, wherein the mesh, the first face layer, and the second face layer are each at least partially formed from a same thermoplastic material.

8. A composite panel comprising:
a thermoplastic mesh core;
a first face layer comprising a thermoplastic material welded to a first side of the thermoplastic mesh core; and
a second face layer comprising a thermoplastic material welded to a second side of the thermoplastic mesh core.

9. The composite panel of claim 8, wherein the composite panel has a density of between 0.5 grams per cubic centimeter and 1.6 grams per cubic centimeter.

10. The composite panel of claim 8, wherein the thermoplastic mesh core comprises pores having an average width equal to or less than a thickness of the first thermoplastic face layer.

11. The composite panel of claim 8, wherein the thermoplastic mesh core has a thickness between 0.3 and 1.4 millimeters.

12. A method for manufacturing a composite panel, the method comprising:
coupling a first face layer to a first side of a mesh core; and
coupling a second face layer to a second side of the mesh core to form the composite panel, wherein the mesh core has a thickness of between 0.3 and 1.4 millimeters.

13. The method of claim 12, wherein coupling the first face layer to the first side of the mesh core and the coupling the second face layer to the second side of the mesh core comprises welding the first face layer and the second face layer to the mesh core.

14. The method of claim 12, wherein welding the first face layer and the second face layer to the mesh core comprises pressing the first face layer against the first side of the mesh core and the second face layer against the second side of the mesh core while applying heat.

15. The method of claim 12, wherein coupling the first face layer to the first side of the mesh core and the coupling of the second face layer to the second side of the mesh core comprises adhering the first face layer and the second face layer to the mesh core via an adhesive.

16. The method of claim 14, wherein applying the adhesive comprises spraying the adhesive.

17. The method of claim 12, wherein coupling the first face layer to the first side of the mesh core and coupling the second face layer to the second side of the mesh core comprises applying pressure via compression surfaces equipped with a motion-limiting shim to control a thickness of the composite panel.

18. The method of claim 12, wherein coupling the first face layer and the second face layer to the first side of the mesh core and the second side of the mesh core comprises pressing the first face layer and the second face layer to the mesh core via rollers.

19. The method of claim 12, further comprising forming the composite panel into a product shape.

20. The method of claim 19, wherein forming the composite panel into the product shape comprises one or more of cutting the composite panel after coupling the first face layer and the second face layer to the mesh core, thermoforming the composite core into the product shape, and sealing an edge of the product shape.
